(19) United States
(12) Patent Application Publication
(10) Pub. No.: US 2009/0028321 A1
(43) Pub. Date: Jan. 29, 2009

(54) Echo Path Change Detection in a Network Echo Canceller

(76) Inventor: Jun Cheng, Solna (SE)

Correspondence Address: ERICSSON INC., 6300 LEGACY DRIVE, M/S EVR 1-C-11, PLANO, TX, 75024, US

(21) Appl. No.: 12/092,848

(22) PCT Filed: Nov. 8, 2005
(86) PCT No.: PCT/EP05/11919

§ 371 Date: May 7, 2008

(51) Int. Cl. H04B 3/23; H04M 9/08

(52) U.S. Cl. 379/406.08; 381/66

(57) ABSTRACT

An echo canceller is proposed that has an echo path change detector (10) capable of reliably distinguishing an echo path change from the condition of double talk. The echo path change detector is adapted to sample filter parameters from an FIR adaptive filter in the echo canceller, and to detect a change in intensity in a pattern formed by the sampled filter parameters. An echo path change is signalled when the degree of said pattern intensity change exceeds a predetermined level. The invention resides in the understanding that the parameters or coefficients of the adaptive FIR filter react differently to a condition of double talk or echo path change. Specifically, when these parameters are sampled and represented as an intensity pattern, a significant change in this intensity pattern over time can indicate an echo path change.

### FIELD OF INVENTION

The present invention relates to the cancelling of network echo in either fixed or digital mobile telephone systems.

### BACKGROUND ART

In today's digital mobile telephone systems, the two main factors affecting speech quality are network delay, resulting from the combination of speech coding and channel coding, and network echo. Network echo is the result of a portion of the speech signal energy from a “far end” subscriber being reflected back to the sender. This is caused primarily by the impedance mismatch in the 4-wire to 2-wire conversion hybrid in the public switched telephone network (PSTN) subscriber interface. Any network delay makes network echo more apparent, and hence more irritating to the subscriber.

It is known to use an echo canceller to reduce or remove the network echo and hence improve the overall speech quality. Conventional echo cancellers use an adaptive finite impulse response (FIR) filter to model the echo path, generate a replica of the echo and subtract this from the “near end” signal to cancel the echo component. The adaptive FIR filter coefficients or parameters are updated by a least mean square (LMS) algorithm to minimise the prediction error of the adaptive filter. The adaptive FIR filter only models the linear portion of the echo. Non-linear effects from the conversion hybrid and the subscriber, such as saturation and unsymmetrical distortion, limit the echo canceller performance to around 30 dB echo return loss. In order to remove this residual echo the echo canceller also uses a nonlinear processor.

When the echo path impulse response changes (hereinafter called “echo path change”), the FIR filter uses the prediction error to update the FIR filter coefficients or parameters. However, the FIR filter is unable to distinguish an echo path change from a condition called double talk, which arises when both subscribers talk at once. In this latter situation, the residual signal is dominated by the “near end” signal rather than by echo. However, this effect, in a similar fashion to an echo path change, causes the prediction error to increase. This is problematic because when double talk occurs, the FIR filter parameters should be frozen to prevent deviation, rather than updated as they would be for an echo path change. On the other hand, when an echo path change occurs, the adaptation rate should be increased in order to speed up convergence of the adaptive FIR filter to remove the echo.

A number of methods for detecting the conditions of double talk and echo path change in an echo canceller have been proposed. C. Carlemalm, F. Gustafsson and B. Wahlberg, (1996) “On the problem of detection and discrimination of double talk and change in the echo path” Proc. ICASSP '96, Atlanta, pp 2742-2745 and C. Carlemalm, (1998) “On model-based detection and estimation schemes in statistical signal processing” Ph. D. Thesis, Royal Institute of Technology, Stockholm, both suggest using a likelihood-based approach. Both the latter reference and C. Carlemalm and A. Logothetis (1997) “On detection of double talk and changes in the echo path using a Markov modulated channel model” Proc. ICASSP '97, Munich. present a hidden Markov model method. The use of such methods to model the echo path and then detect echo path change or double talk provides good results in computer simulations, but still does not permit 100% detection. Particularly in the last-mentioned reference, the detection of echo path change appears easier than that of double talk. However, this comes at the expense of high computational complexity when this method is put into practice. The complexity of the likelihood-based approach has been estimated as roughly equivalent to that of two recursive least square RLS filters; the complexity for the hidden Markov model method is reportedly less than this, but nevertheless is still difficult to implement in practice in a cellular network application.

WO 98/28857 describes a method for detecting echo path change and double talk by measuring and comparing the linear dependencies between the residual signal and the echo estimate and between the residual signal and the desired signal. While this method is very effective it is unable to provide sufficiently rapid convergence when the path changes during an established call, for example when the far end signal is switched from one phone to another in some situations.

It is thus an object of the present invention to propose a method and apparatus for reliably distinguishing an echo path change from the condition of double talk.

It is a further object of the present invention to propose a method and apparatus for providing an echo path change detector that can be implemented with low computational complexity.

It is a further object of the present invention to propose a method and apparatus for detecting an echo path change with a rapid response.

It is a still further object of the present invention to present a method and apparatus for echo cancellation that reliably and rapidly distinguishes an echo path change from the condition of double talk.

### SUMMARY OF THE INVENTION

The above objects are achieved in an arrangement and method as set out in the accompanying claims.

In accordance with one aspect, the present invention resides in an echo canceller for use in telecommunication system that has a finite impulse response adaptive filter with modifiable filter parameters and an echo path change detector coupled to the final impulse response filter. The echo path change detector is adapted to sample the FIR filter parameters over time and to detect a change in a pattern formed by the sampled filter parameters. An echo path change is signalled when the degree of said pattern change exceeds a predetermined level. Preferably the detected pattern change is a change in an intensity pattern formed by the sampled filter parameters.

In essence, the present invention resides in the understanding that the parameters or coefficients of the adaptive finite impulse response filter of the echo canceller react differently when confronted with the condition of double talk or with an echo path change, respectively. Specifically, when these parameters are sampled and represented as an intensity pattern, a significant change in this intensity pattern over time can indicate an echo path change.

Preferably, the intensity pattern of the filter parameters is represented by the intensity levels in the areas of high intensity by determining the difference between the highest and lowest filter parameters for each set of sampled parameters. This greatly simplifies the generation of a signal representing the intensity pattern and also reduces the necessary computational capacity.

A gradual change in such areas of high intensity in the parameter intensity pattern is a characteristic of an echo path change and thus contributes towards differentiating an echo path change from double talk. In accordance with a preferred embodiment of the invention, a change in this intensity pattern is determined by generating an average level of these difference signals. When the newly calculated intensity signal differs by a predetermined level from the long-term average level, this indicates an echo path change.

Preferably, this long-term average is generated using a low-pass filter. The intensity signal should anyway be filtered to remove noise and other artefacts, so the echo path change detector preferably includes two low pass filters. A first low-pass filter has a short time constant suitable for rejecting artefacts. A second low-pass filter has a longer time constant suitable for additionally generating a long-term average intensity level. These two filter outputs are then compared and when the difference exceeds a predetermined level, an echo path change is signalled.

The predetermined level may be a fixed level, but is preferably set as a percentage of the long-term average intensity signal.

### BRIEF DESCRIPTION OF THE DRAWINGS

Further objects and advantages of the present invention will become apparent from the following description of the preferred embodiments that are given by way of example with reference to the accompanying drawings. In the figures:

FIG. 1 schematically illustrates an echo canceller including an echo path change detector in accordance with the present invention and

FIG. 2 schematically illustrates the equivalent circuit of a conventional echo canceller,

FIG. 3 depicts samples of parameters of the FIR filter in a conventional echo canceller under the application of a DT test signal, which simulates the presence of low-level near end speech signals,

FIG. 4 depicts the same samples of parameters of the FIR filter as shown in FIG. 3 in the absence of low-level near end speech signals,

FIG. 5 depicts samples of the FIR filter parameters before and after an echo path change, and

FIG. 6 schematically depicts the functional elements of an echo path change detector in accordance with the present invention.

### DETAILED DESCRIPTION OF THE DRAWINGS

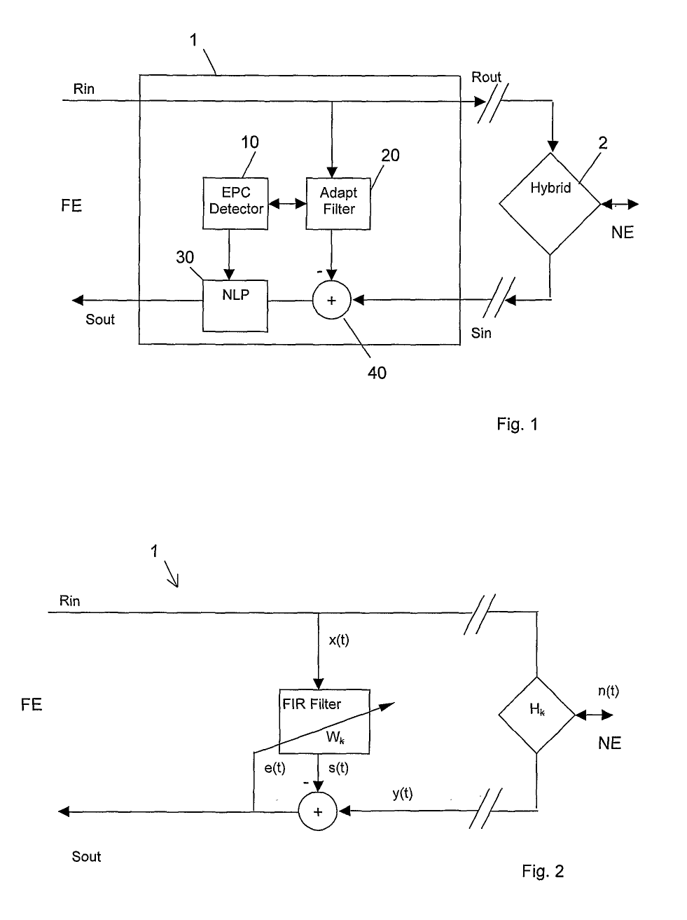

FIG. 1 shows a simplified schematic representation of an echo canceller 1 in accordance with the present invention. The echo canceller 1 receives a first input signal, Rin, from a far end, FE, and a second input signal Sin at a near end, NE. The near end, NE, or cancelled end, of the echo canceller contains the echo path on which the echo canceller I operates. This includes all transmission facilities and equipment that are included in the echo path, including the 2-wire/4-wire hybrid 2 and terminating telephone set (not illustrated).

The main component of the echo canceller 1 depicted in FIG. 1 is an adaptive filter 20, which is a finite impulse response (FIR) filter. This filter 20 uses an adaptation algorithm to model the impulse response of the echo path and generate a predicted echo signal. This predicted signal is then subtracted at element 40 from the near end signal Sin to cancel the echo component and generate an echo-free output signal Sout. A non-linear processor (NLP) 30 is used to remove residual echo that may remain after linear processing of the input signal. It will be understood by those skilled in the art that the echo canceller may also contain other elements not illustrated here, such as a fixed filter, DC filters and comfort noise generators.

Also depicted in FIG. 1 is an echo path change (EPC) detector 10. This is coupled to both the FIR filter 20 and the non-linear processor 30. As will be described below, the echo path change detector 10 detects an echo path change by analysing the parameters of the FIR filter 20.

The adaptive FIR filter parameters are updated using a least mean square (LMS) algorithm to minimise the prediction error of the FIR filter 20. The quality of the echo path estimation depends on the step size of this adaptation algorithm. A small estimation error is generated by using a small step size, but this comes at the cost of slow adaptation or “convergence” rate. A larger step size results in a higher adaptation rate. When a change in the echo path is signalled by the echo path change detector 10, this causes the modification of the step size used in the LMS algorithm of the FIR filter 20, as well as a change in the clip level in the non-linear processor 30.

In accordance with the present invention, the detection of echo path change as distinguished from the condition of double talk is based on the realisation that the FIR filter parameters are affected differently by these two conditions. This can be explained with reference to FIG. 2, which shows the equivalent circuit of a conventional echo canceller without an echo path change detector.

In the diagram of FIG. 2, x(t) denotes the received (far end) signal; the near end signal is denoted by n(t), s(t) is the predicted echo on the received signal x(t), y(t) is the received echo signal plus the near end signal n(t), W is the weighting factor for each FIR parameters k at time t; H is the impulse response of the hybrid, and e(t) is the echo-cancelled received signal and is a combination of a residual (estimation error) signal and the near end signal.

The predicted echo on the received signal x(t) can be expressed as follows:

$$s ( t ) = {\sum }_{k = 0}^{K - 1} {W}_{k} ( t ) x ( t - k ) \qquad ( 1 )$$

The desired signal y(t) may be expressed as follows:

$$y ( t ) = {\sum }_{k = 0}^{K - 1} {H}_{k} ( t ) x ( t - k ) + n ( t ) \qquad ( 2 )$$

Finally, the echo-cancelled received signal, e(t) can be expressed as shown in equation (3).

$$e ( t ) = y ( t ) - s ( t ) = {\sum }_{k = 0}^{K - 1} ( {H}_{k} ( t ) - {W}_{k} ( t ) ) x ( t - k ) + n ( t ) \qquad ( 3 )$$

It is apparent from equation (3) that as W approaches H, the estimation error, e(t), approaches the near end signal n(t) and will equal this in the ideal condition. Echo cancellation is transparent to the near end and serves to isolate the far end signal. When either an echo path change or double talk occurs, the residual signal e(t) will be increased in either the first or second part of equation (3). But, is it difficult to identify which of these conditions has occurred simply by evaluating the increased e(t). However, there is a difference in the way the FIR parameters are modified in these two conditions. Specifically, when an echo path change occurs, the impulse response of the hybrid, H, jumps away from the FIR parameters, W, after which the FIR parameters, W, track the changes in H. The same behaviour is not displayed in the condition of double talk because the near end speech signal does not contribute consistently to the FIR parameter estimation. This observation opens up the possibility of detecting echo path change reliably and without confusing it with the condition of double talk by monitoring and identifying the parameter behaviour.

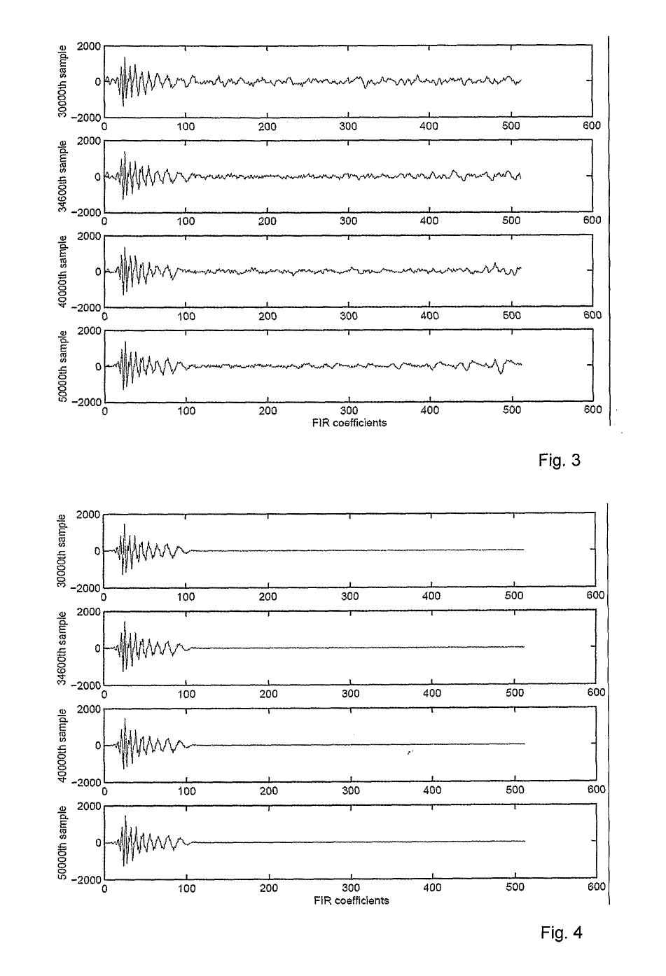

This difference in behaviour of the filter parameters in response to double talk or an echo path change is illustrated in FIGS. 3 to 5.

FIG. 3 shows four samples of 512 FIR filter parameters using test signals defined in ITU-T recommendation G.168 Test 3A, which represent double talk with low near-end speech levels. FIG. 4 shows the same sample times as in FIG. 3 in the absence of near end low-level speech.

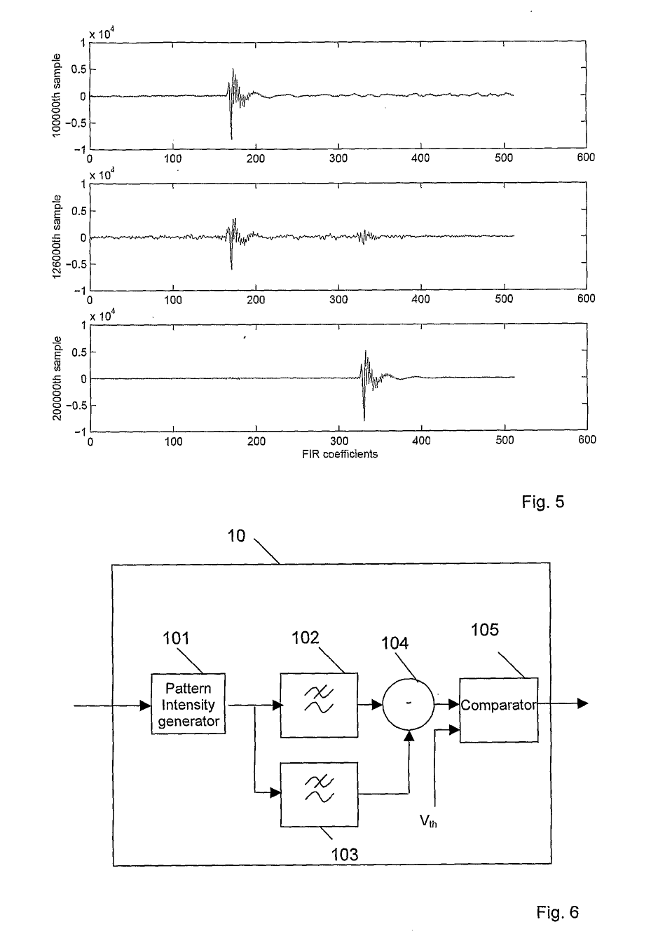

FIG. 5 shows the effect on FIR parameters of a test signal representing an echo path change. This test is carried out in the absence of an echo path change detector. In FIG. 5, the EPC occurs at sample number 124400. The parameters are illustrated before the EPC (at sample 10000), 200 ms after the EPC (at sample 126000) and later still (at sample 200000).

It is apparent from a comparison of FIGS. 3 and 4, which respectively show parameters in the presence and absence of double talk, that a near end signal (low level speech) affects all parameters to a degree. The effect of an echo path change shown in FIG. 5, however, is markedly different. The FIR parameters reproduce the impulse response of the hybrid. An echo path change essentially shifts or scales this response. The transition between the old impulse response and the new impulse response can be described as a change in intensity and/or position of the pattern formed by the FIR parameters. A high intensity object fades out at one position while a new high intensity object fades in at the same or a new position.

By viewing the FIR parameters as a one-dimensional intensity pattern it is possible to identify the occurrence of an echo path change as a consistent change in intensity, position or both, of the parameter pattern.

The echo path change detector according to the present invention uses a change in the pattern intensity of the FIR parameters to detect an echo path change reliably. The echo path change detector 10 is illustrated schematically in FIG. 6. As shown in the figure, this detector includes a pattern intensity generator 101, two low pass filters 102, 103, connected in parallel to the output of the pattern intensity generator, a difference calculator 104 and a comparator 105 arranged to compare the outputs of the low pass filters 102, 103 and generate an output signal indicative of a detected echo path change. This output signal is then sent to the FIR filter 20 and the non-linear processor 30 illustrated in FIG. 1. The function and implementation of these elements or functional modules is described in more detail below.

The pattern intensity generator 101 receives the FIR parameter values from the FIR filter 20 shown in FIG. 1 and generates a signal representative of the intensity pattern of these parameters.

The properties of a two-dimensional pattern in terms of its intensity, position, area and the like may be described using the method of moments. The moment of an object is defined as

$${M}_{pq} = \sum {\sum }_{( x , y ) ∈ R} {x}^{p} {y}^{q} f ( x , y ) \qquad ( 4 )$$

where p+q represents the order of the moment, x and y are pixel coordinates, f(x,y) represents the pixel intensity function and R is the space where the object is located.

To reduce computational complexity, it is possible to use only the zero and first order moments to describe the FIR parameters. These are:

$$\begin{matrix}{M}_{00} = \sum {\sum }_{( x , y ) ∈ R} f ( x , y ) & ( 5 ) \\ {M}_{10} = \sum {\sum }_{( x , y ) ∈ R} xf ( x , y ) \\ and & ( 6 ) \\ {M}_{01} = \sum {\sum }_{( x , y ) ∈ R} yf ( x , y ) & ( 7 )\end{matrix}$$

The centroid coordinates of the object, i.e. the center of gravity of the intensity pattern, are then:

$${x}_{c} = \frac{{M}_{10}}{{M}_{00}} and {y}_{c} = \frac{{M}_{01}}{{M}_{00}} \qquad ( 8 )$$

In order to reduce the computational complexity required in an echo path change detection algorithm the pattern intensity generator 101 performs a modified version of equations (4) to (8) to obtain the instantaneous pattern intensity, Iᵢₙₛₜₐₙₜ. This is represented by the following equation:

Iᵢₙₛₜₐₙₜ=FIRₘₐₓ−FIRₘᵢₙ (9)

where FIRₘₐₓ and FIRₘᵢₙ are the maximum and minimum FIR filter parameters (coefficients), respectively. In other words, the two brightest pixels are used to represent the intensity of the FIR parameter pattern. The instantaneous pattern intensity indicates the level of the predicted echo on the received far end signal. The coordinates of the intensity pattern provide information on the delay of the echo path. This simplification of equations (4) to (8) permits the instantaneous pattern intensity to be calculated in real time without great computational capacity.

Low-pass filter blocks 102 and 103, process the instantaneous pattern intensity to obtain information extraction and artefact rejection, such as the rejection of low-level near-end speech and noise. This is essentially a smoothing of the estimated FIR parameter intensity pattern, and has a function represented by the following equation:

$$I ( t ) = I ( t - 1 ) + \frac{( {I}_{instant} << 16 ) - I ( t - 1 )}{{2}^{shift}} \qquad ( 10 )$$

This smoothing function defined in equation 10 is performed in each of the low pass filter blocks 102, 103 using 1^{st} order infinite impulse response (IIR) filters. In this equation 2^{shift} is the smoothing factor, which can be achieved using shifts and without the need for multiplication. Incidentally, it is noted that the operator “<<” used in equation (10) enables the increase in calculation resolution when performing the division. Each low pass filter block 102, 103 applies a different smoothing factor. Filter block 102 has a longer time constant than filter block 103. The respective time constants are selected such that filter block 102 generates a long-term average of the FIR parameter pattern, while filter block 103 generates the estimated instantaneous FIR parameter pattern intensity, filtered to remove noise and low level near end speech.

The outputs of blocks 103 and 102, representing the instantaneous and long-term pattern intensity signals, respectively, are then compared in the difference calculator 104 and comparator 105.

Measurements have shown that, in general, double talk generates a less than 10% change in the FIR parameter intensity pattern. Moreover, the effect of double talk on the FIR parameter pattern is somewhat random, depending on the speech pattern. An echo path change, on the other hand, may generate a more than 30% change in the FIR parameter pattern for a specific time interval, typically around 100 ms. Any low-level near end speech and noise present on the FIR parameter pattern intensity signals can be smoothed away by the filter functions. Any remaining signals caused by the presence of a near-end speech signal are then ignored by setting a threshold level. A change in the instantaneous FIR parameter pattern intensity level relative to the long-term FIR parameter pattern intensity level that exceeds this threshold indicates that the echo path has changed. Accordingly, the difference between the long-term average FIR parameter intensity and instantaneous FIR parameter intensity values output by the difference calculator 104 is compared in the comparator 105 with a detection threshold level Vₜₕ. If this threshold level is exceeded, an echo path change is flagged, permitting the modification of the step size used in the LMS algorithm of the FIR filter 20, as well as a change in the clip level in the non-linear processor 30.

This threshold level Vₜₕ may be an absolute, or fixed level. Alternatively and preferably, however, it is a percentage change of the long-term average FIR parameter intensity value output by low pass filter 102. The threshold level is preferably set in the range of 10-30%, and most preferably in the range of 20-25%, of the long-term average FIR parameter intensity level.

The computational capacity required for the echo path change detection algorithm may be reduced still further by performing echo path change detection over 32 sample intervals, such that the detection algorithm is repeated only for every 32 sample.

The echo path change detector 10 described above is preferably implemented in software in a digital signal processor (DSP). Since the echo canceller 1 itself is conventionally implemented as a software algorithm using a DSP, the echo path change detector 10 can then form an extension of the echo canceller algorithm. Alternatively, those skilled in the art will readily recognise that the algorithm used by the echo path change detector 10 may be implemented in hardware, for example, using field programmable gate array (FPGA).

The echo canceller 1 including the path change detector 10 can be incorporated in the public switched telephone network PSTN. It can also be installed in an edge node of a core network portion of a digital mobile communication network to remove the echo generated in the PSTN. In 3G networks, for example, the echo canceller 1 with the path change detector 10 would be incorporated in a media gateway that connects the mobile network to the PSTN.

1. An echo canceller for use in a telecommunication system, the echo canceller comprising:
a finite impulse response adaptive filter having a set of modifiable filter parameters; and
an echo path change detector coupled to said finite impulse response filter, wherein said echo path change detector is adapted to receive samples of said set of filter parameters over time, to detect a change in a pattern formed by said filter parameters sampled over time and to signal an echo path change when the degree of said pattern change exceeds a predetermined level.

2. The echo canceller according to claim 1, wherein the echo path change detector includes a pattern intensity generator adapted to generate an intensity signal representing a pattern intensity of said sampled set of filter parameters, and an intensity change detector adapted to identify a change in said intensity signal over time.

3. An echo canceller for use in a telecommunication system, the echo canceller comprising:
a finite impulse response adaptive filter having a set of modifiable filter parameters; and
an echo path change detector coupled to said finite impulse response filter, wherein said echo path change detector includes a pattern intensity generator adapted to receive samples of said set of filter parameters over time and to generate an intensity signal representing the pattern intensity of said sampled set of filter parameters, and an intensity change detector adapted to identify a change in said intensity signal over time and to signal an echo path change when the degree of said pattern intensity change exceeds a predetermined level.

4. The echo canceller according to claim 3, wherein said pattern intensity generator is adapted to calculate the difference between a maximum and a minimum adaptive filter parameter values for each set of sampled parameters.

5. The echo canceller according to claim 3, wherein said intensity change detector includes a first low pass filter having a first time constant, a second low pass filter having a second time constant longer than said first time constant and a comparator connected to the output of said first and second low pass filters, wherein said first and second low pass filters are arranged to receive said intensity signal and to output, respectively a short-term average and long-term average of said intensity signal, and said comparator is arranged to determine a difference between the short-term and long-term averages and to ascertain an occurrence of echo path change when the short-term average differs from the long-term average by a predetermined level.

6. The echo canceller according to claim 5, wherein said predetermined level is set at a percentage of the output of said second low pass filter.

7. The echo canceller according to claim 5, wherein said predetermined level is set in a range of 10-30% of the output of said second low pass filter and preferably between 20-25% of the output of said second low pass filter.

8. The echo canceller according to claim 3, wherein said finite impulse response adaptive filter includes an adaptation algorithm, and in that said adaptive filter is adapted to respond to a signaled echo path change by modifying a step size in said adaptation algorithm.

9. The echo canceller according to claim 3, further comprising at least one non-linear processor adapted to respond to a signaled echo path change by modifying a clip level.

10. A method for detecting an echo path change for use in an echo canceller having an adaptive finite impulse response filter, said method comprising the steps of:
sampling sets of filter parameter from said adaptive finite impulse response filter over time,
determining a change in intensity in an intensity pattern formed by said filter parameters sampled over time and
signaling an echo path change when the degree of said pattern intensity change exceeds a predetermined level.

11. The method according to claim 10 wherein the step of determining a change in intensity in said filter parameter intensity pattern includes the step of: generating an intensity signal representative of the pattern intensity of said sampled filter parameters.

12. The method according to claim 11, wherein said step of generating an intensity signal includes the step of calculating the difference between a maximum and a minimum adaptive filter parameter values in each set of sampled filter parameters to generate said intensity signal.

13. The method according to claim 11, wherein the step of determining a change in intensity in said filter parameter intensity pattern includes the steps of:
generating a long-term average of said intensity signal; and
determining if said intensity signal differs from said long-term average by said predetermined level.

14. The method according to claim 13 further comprising the step of low-pass filtering said intensity signal using a first time constant to generate said long-term average and a second time constant shorter than said first time constant to generate an instantaneous pattern intensity signal and comparing the outputs of said first and second low pass filters to determine if said instantaneous pattern intensity signal differs from said long-term average by said predetermined level.

15. The method according to claim 13, further comprising the step of setting said predetermined level at a percentage of said long-term average of said intensity signal.

16. The method according to claim 13, further comprising the step of setting said predetermined level at between 10-30% of said long-term average of said intensity signal, and between 20-25% of said long term average of said intensity signal.
